(19) United States
(12) Patent Application Publication
(10) Pub. No.: US 2009/0223752 A1
(43) Pub. Date: Sep. 10, 2009

(54) DISK BREAK APPARATUS FOR ELECTROMECHANICAL BRAKE SYSTEM

(75) Inventor: Soohoon KIM, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/256,146

(22) Filed: Oct. 22, 2008

(30) Foreign Application Priority Data
Mar. 6, 2008 (KR) 10-2008-0020909

(51) Int. Cl. B60T 13/74

(52) U.S. Cl. 188/72.1

(57) ABSTRACT

A disk brake apparatus for an electromechanical brake system according to an exemplary embodiment of the present invention includes a first motor and a second motor. The first motor is provided for front wheels and rear wheels, for power transmission with a sun gear of a planetary gear set; and the second motor is provided for the front wheels and second wheels, for power transmission with a ring gear of the planetary gear set, wherein the second motor connected with the ring gear is disposed outside from the first motor connected with the sun gear.

### CROSS-REFERENCE TO RELATED APPLICATIONS

The present application is based on, and claims priority from, Korean Application Serial Number 10-2008-0020909, filed on Mar. 6, 2008, the disclosure of which is hereby incorporated by reference herein in its entirety.

### FIELD OF THE INVENTION

The present invention relates to a disk brake apparatus, and more particularly disk brake apparatus for an electromechanical brake system.

### BACKGROUND OF THE INVENTION

In general, an electromechanical brake system (hereafter, referred to as EMB system), the next generation brake system, is a system that senses the driver's intention of braking a vehicle using a pedal simulator, and then controls the brake pressure of the front wheels and rear wheels, using a motor.

In addition to a general braking function, an ABS (Anti-Lock Brake System) function, and a VDC (Vehicle Dynamic Control) function, the EMB system allows all intelligent braking functions, including an automatic braking function that is required for an intelligent cruise control system that will be used in the close future.

Technologies considering safety of a vehicle have been considerably developed and development of an active safe system has been carried out, by integrating technologies of electronics and control engineering.

In particular, it can be said that a brake system is given much weight in a vehicle accident and the safety system and the present braking technology is used to control the position of a vehicle when it is accelerated or is in normal travel.

Since the brake system is given much weight in the safety of a vehicle as described above, requirement of the active safe system has been increased, and particularly, necessity of the intelligent brake system for an ITS vehicle equipped with an intelligent cruise control system, which will come into the market, is on an increasing trend.

As a variety of functions has been required for such a brake system, pumps or valves needed for an existing hydraulic circuit for braking have been added or modified, but the specification should be changed again to be used for a vehicle with the intelligent cruise control system.

Therefore, efforts for providing simple and various function to an existing brake system that has been used in an ABS and VDC in the related art have been made, and typically, an electro-hydraulic brake system (EHB system) and an EMB system that estimates appropriate pressure using a controller according to pedal effort applied by a driver and other signals generated by sensors and controls the brake pressure according to the signal has been known in the related art.

It is considered that the EMB system gradually replace the ABS and VDC hydraulic systems and it is estimated that the EMB system sufficiently satisfies demand as an actuator in an electric vehicle or a brake actuator in an intelligent vehicle, such as the intelligent cruise control system.

FIG. 1 schematically shows the entire configuration of a common EMB system.

When a driver operates a brake pedal 1, singles are inputted to a main control unit 4 from a brake pedal switch 2 and a brake pedal operation force detecting sensor 3.

Main control unit 4 estimates appropriate pressure according to the operation pressure of brake pedal 1 and signals of a barking force sensor 5 and a wheel speed sensor 6, and then transmits signals corresponding to the estimated value to a first sub-control unit 7 and second sub-control unit 8.

As a first driving unit 11 and a second driving unit 12 are driven in response to signals of first sub-control unit 7 and second sub-control unit 8 respectively and a disk brake apparatus 20 equipped to front wheels 13 and rear wheels 14 are actuated by the operation of first driving unit 11 and second driving unit 12, an appropriate braking force is applied.

Meanwhile, reference numerals 15, 16, 17, 18, and 19 indicate an engine, an automatic transmission, a main battery, a first sub-battery, and a second sub-battery, respectively. Further, reference numerals '21, 26, and 27 indicate a disk, a first motor, and a second motor that are included in disk brake apparatus 20.

FIG. 2 illustrates the configuration of disk brake apparatus 20 in the related art.

The disk brake apparatus shown in FIG. 2 includes two motors and a planetary gear set 25, and disk brake apparatus 20 in the related art further includes disk 21 that rotates with the wheel and a friction pad 22 that is selectively pressed against a friction surface 21a of disk 21 to prevent rotation of disk 21. A cylindrical inner screw member 23 with threads on the outer circumference is fastened to friction pad 22 and is engaged with a cylindrical outer screw member 24 with threads on the inner circumference thereof.

That is, as outer screw member 24 rotates, inner screw member 23 reciprocates.

Outer screw member 24 is connected with a planetary gear set 25 for power transmission and planetary gear set 25 is connected with first motor 26 and second motor 27 for power transmission.

As disclosed in the related art, planetary gear set 25 is composed of a sun gear 25a, planetary gears 25b, a carrier 25c, and a ring gear 25d, in which sun gear 25a is directly connected with first motor 26, planetary gears 25b are engaged with the outer circumference of sun gear 25a and connected to carrier 25c to revolve around sun gear 25a.

Carrier 25c makes an output and is connected to outer screw member 24 for power transmission, and ring gear 25d that is an internal gear with teeth on the inner circumference is engaged with planetary gears 25b and connected with second motor 27 for power transmission.

Therefore, as first and second motors 26, 27 equipped to front wheel 13 and rear wheel 14 are activated by the operation of first and second driving units 11, 12 and carrier 25c of planetary gear set 25 correspondingly rotates, outer screw member 24 rotates and inner screw member 23 reciprocates. As a result, friction pad 22 is selectively pressed against friction surface 21a of disk 21 that is rotating and a barking force applied.

However, according to disk brake apparatus 20 having the above configuration in the related art, because first and second motors 26, 27 are coaxially connected in a series in the left-right direction, i.e. the width direction of the car body, planetary gear set 25 is large in length L1 from the left to the right, i.e. width, and accordingly, a large space is needed in the left-right direction, i.e. the width direction of the car body and it is difficult to secure high freedom in the layout.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a disk brake apparatus for an electromechanical brake system including two motors and a planetary gear set, in which the planetary gear set is considerably reduced in length in the left-right direction, i.e. the width direction of the car body by disposing a second motor outside from a first motor, such that it is possible to secure high freedom in the layout and effectively dispose the disk brake apparatus in a small space.

A disk brake apparatus for an electromechanical brake system according to an exemplary embodiment of the present invention includes a first motor and a second motor. The first motor is provided for front wheels and rear wheels for power transmission with a sun gear of a planetary gear set. The second motor is provided for the front wheels and second wheels for power transmission with a ring gear of the planetary gear set. Further, the second motor connected with the ring gear is disposed outside from the first motor connected with the sun gear.

In another exemplary embodiment of the present invention, a disk brake apparatus for an electromechanical brake system, may comprise a first motor connected with a sun gear of a planetary gear set for power transmission; and a second motor connected with a ring gear of the planetary gear set for power transmission, wherein the first motor and the second motor are disposed co-axially and in series each other, and the second motor substantially surrounds an outer circumference of the ring gear. The second motor may include: a stator that has a metal core supporting a wire and a frame supporting the metal core; and a rotator that is formed of a hollow shaft and rotatably disposed inside the stator. The ring gear of the planetary gear set may be fitted in the rotator.

According to the disk brake apparatus of the invention, since the length of planetary gear set, which is included in the disk brake apparatus, in the width direction, i.e. in the left-right direction of the car body, is significantly reduced and the high freedom for disk brake apparatus in the layout can be secured, it is possible to dispose disk brake apparatus in a small space in the left-right direction, i.e. the width direction of the car body.

### BRIEF DESCRIPTION OF THE DRAWINGS

For better understanding of the nature and objects of the present invention, reference should be made to the following detailed description with the accompanying drawings, in which:

FIG. 1 is a schematic view illustrating the entire configuration of a conventional EMB system;

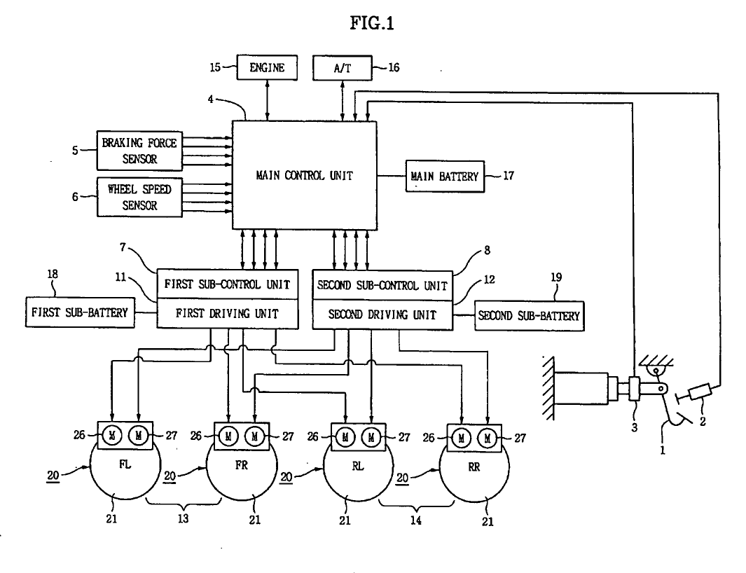

FIG. 2 is a view illustrating a disk brake apparatus according to the related art, in the EMB system shown in FIG. 1;

FIG. 3 is a schematic view illustrating the entire configuration of an EMB system equipped with a disk brake system according to an exemplary embodiment of the present invention;

FIG. 4 is a view illustrating a disk brake apparatus according to an exemplary embodiment of the present invention, equipped in an EMB system; and

FIG. 5 is a view illustrating a second motor of a disk brake apparatus according to an exemplary embodiment of the present invention.

### DETAILED DESCRIPTION OF THE PREFERRED EMBODIMENTS

Preferred embodiments of the invention are described hereafter in detail with reference to the accompanying drawings.

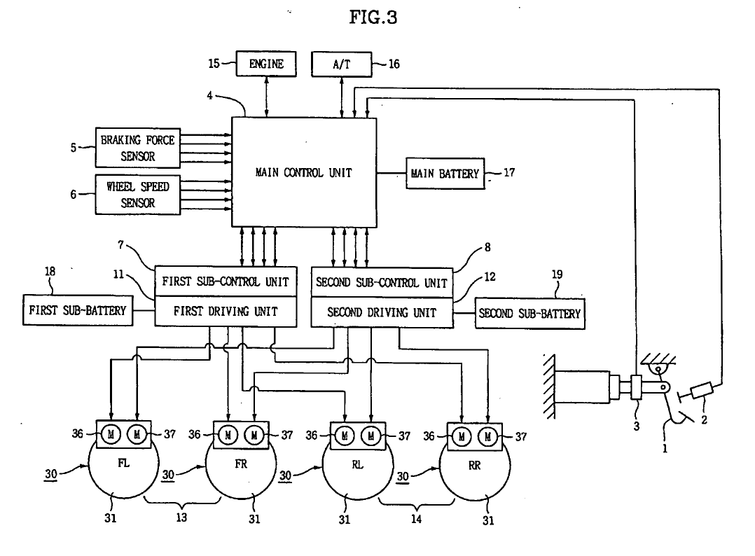

An EMB system according to an exemplary embodiment of the present invention, as shown in FIG. 3, includes a brake pedal 1 that is operated by a driver, a brake pedal switch 2 that detects the operation of brake pedal 1, and a brake operation force detecting sensor 3 that detects the operation force of brake pedal 1.

A main control unit 4, receiving signals from brake pedal switch 2 and brake operation force detecting sensor 3, also receives signals from a braking force sensor 5 and a wheel speed sensor 6.

Main control unit 4 estimates appropriate pressure according to the operation pressure of brake pedal 1 and the signals of braking force sensor 5 and wheel speed sensor 6 and then transmits signals corresponding to the estimated value to a first sub-control unit 7 and a second sub-control unit 8.

Main control unit 4 can transmit/receive signals to/from an engine 15 and an automatic transmission 16 and is supplied with power from a main battery 17.

First sub-control unit 7 and second sub-control unit 8 can control a first driving unit 11 and a second driving unit 12 respectively by generating control signals, and first driving unit 11 and second driving unit 12 are supplied with power from a first sub-battery 18 and a second sub-battery 19 respectively.

First driving unit 11 and second driving unit 12 are designed to actuate disk brake apparatus 30 according to an exemplary embodiment of the present invention, which are each equipped to a front wheel 13 and a rear wheel 14, and disk brake apparatus 30 receives driving forces from first driving unit 11 and second driving unit 12 and generate braking forces.

Meanwhile, reference numerals 31, 36, and 37, which are shown in FIG. 3, indicate a disk, a first motor, and a second motor that are included in disk brake apparatus 30 according to an exemplary embodiment of the present invention.

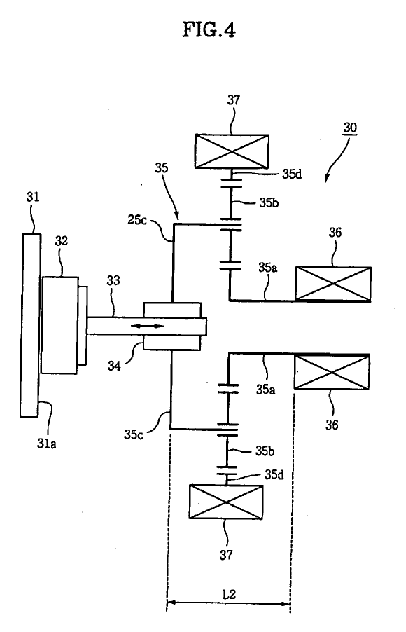

Further, disk brake apparatus 30 according to an exemplary embodiment of the present invention, as shown in FIG. 4, includes disk 31 and a friction pad 32 that is selectively pressed against a friction surface 31 a of disk 31 to prevent rotation of disk 31.

Friction pad 32 is connected with a cylindrical inner screw member 33 with threads on the outer circumference thereof, the inner screw member 33 is engaged with a cylindrical outer screw member 34 with threads on the inner circumference thereof such that as the cylindrical outer screw member 34 rotates, inner screw member 33 reciprocates.

Outer screw member 34 is connected with a planetary gear set 35 for power transmission and planetary gear set 35 is connected with first motor 36 and second motor 37 for power transmission.

Planetary gear set 35 is composed of a sun gear 35a, planetary gears 35b, a carrier 35c, and a ring gear 35d, in which sun gear 35a is directly connected with first motor 36, planetary gears 35b are engaged with the outer circumference of sun gear 35a and connected to carrier 35c to revolve around sun gear 35a.

Carrier 35c makes an output and is connected to cylindrical outer screw member 34 for power transmission, and ring gear 35d is engaged with planetary gears 35b and connected with second motor 37 for power transmission.

That is, second motor 37 is disposed outside from first motor 36 in disk brake apparatus 30 according to an exemplary embodiment of the present invention.

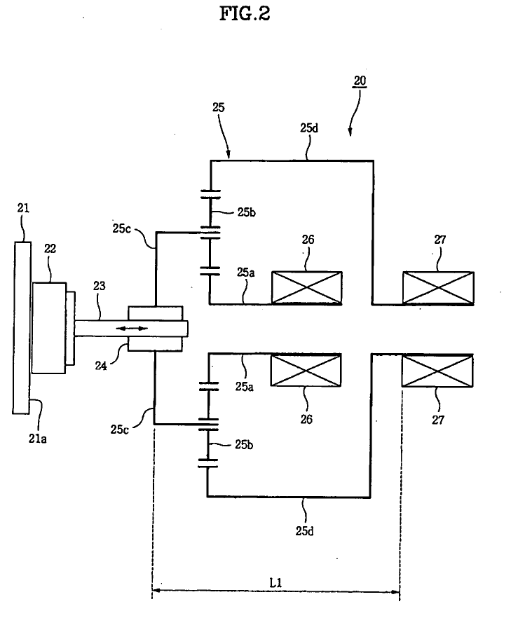

When second motor 37 is disposed outside from first motor 36 as described above, the length L2 of planetary gear set 35 in the width direction (the left-right direction, i.e. the width direction of the car body) is considerably reduced as compared with that in the related art, described above with reference to FIG. 2.

Therefore, it is possible to secure high freedom in the layout for disk brake apparatus 30 according to an exemplary embodiment of the present invention and to effectively dispose disk brake apparatus 30 in a small space in the left-right direction, i.e. the width direction of the car body.

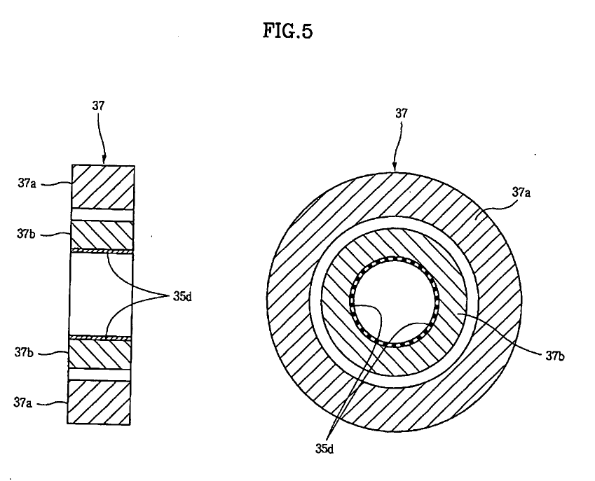

On the other hand, second motor 37, as shown in FIG. 5, includes a stator 37a having a metal core supporting a wire and a frame supporting the metal core and a rotator 37b formed of a hollow shaft and rotatably disposed inside stator 37a.

Further, ring gear 35d of planetary gear set 35 is fitted in rotator 37d.

Accordingly, according to disk brake apparatus 30 of the invention, since the length L2 of planetary gear set 35 in the width direction, i.e. in the left-right direction of the car body, is significantly reduced and the high freedom for disk brake apparatus in the layout can be secured, it is possible to dispose disk brake apparatus 30 in a small space in the left-right direction, i.e. the width direction of the car body.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof It is intended that technical spirit and scope of the present invention be defined by the Claims appended hereto and their equivalents.

What is claimed is:

1. A disk brake apparatus for an electromechanical brake system, comprising:
a first motor that is provided for front wheels and rear wheels, for power transmission with a sun gear of a planetary gear set; and
a second motor that is provided for the front wheels and second wheels, for power transmission with a ring gear of the planetary gear set,
wherein the second motor connected with the ring gear is disposed outside from the first motor connected with the sun gear.

2. The disk brake apparatus as defined in claim 1, wherein the second motor includes:
a stator that has a metal core supporting a wire and a frame supporting the metal core; and
a rotator that is formed of a hollow shaft and rotatably disposed inside the stator.

3. The disk brake apparatus as defined in claim 2, wherein the ring gear of the planetary gear set is fitted in the rotator.

4. A disk brake apparatus for an electromechanical brake system, comprising:
a first motor connected with a sun gear of a planetary gear set for power transmission; and
a second motor connected with a ring gear of the planetary gear set for power transmission,
wherein the first motor and the second motor are disposed co-axially and in series each other, and the second motor substantially surrounds an outer circumference of the ring gear.

5. The disk brake apparatus as defined in claim 4, wherein the second motor includes:
a stator that has a metal core supporting a wire and a frame supporting the metal core; and
a rotator that is formed of a hollow shaft and rotatably disposed inside the stator.

6. The disk brake apparatus as defined in claim 5, wherein the ring gear of the planetary gear set is fitted in the rotator.
